(19) United States
(12) Patent Application Publication
(10) Pub. No.: US 2006/0288159 A1
(43) Pub. Date: Dec. 21, 2006

(54) Method of controlling cache allocation

(75) Inventors: Takaaki Haruna, Tokyo (JP); Yuzuru Maya, Sagamihara (JP); Masami Hiramatsu, Kawasaki (JP)

Correspondence Address: Stanley P. Fisher;Reed Smith LLP, Suite 1400, 3110 Fairview Park Drive, Falls Church, VA, 22042-4503, US

(73) Assignee: Hitachi, Ltd.

(21) Appl. No.: 11/245,173

(22) Filed: Oct. 7, 2005

(30) Foreign Application Priority Data
Jun. 17, 2005 (JP) 2005-177540

(51) Int. Cl. G06F 13/00; G06F 12/00

(52) U.S. Cl. 711/113; 711/170

(57) ABSTRACT

A method of controlling cache allocation to be executed by a server computer is arranged to realize resource management for securing a proper cache size. The server computer is arranged to have a memory unit and a CPU. The memory unit stores a memory allowable size of a memory to be secured as a disk cache by each of the programs to be executed by the server computer. In a case that a new disk cache is allocated to the memory unit when accessing a disk drive under the control of the program being executed, the CPU reads from the memory the memory allowable size corresponding with the program and allocates the disk cache to the memory unit so that the disk cache may stay in the range of the memory allowable size.

### INCORPORATION BY REFERENCE

The present application claims priority from Japanese application JP 2005-177540 filed on Jun. 17, 2005, the content of which is hereby incorporated by reference into this application.

### BACKGROUND

The present invention relates to a method of controlling cache allocation being used in a computer that makes access to a disk through a disk cache.

In general, computers including a Web server, an application server and a database server operate to execute predetermined processes as they input and output data to and from an external storage unit such as a harddisk. Under these conditions, today, for speeding up an apparent process, a method is prevailing in which an operating system (OS) temporarily inputs and outputs data into and from a temporary storage area secured on a memory such as a buffer or a cache. If this kind of method is adopted, the operating system reflects the contents of data inputted into and outputted from the temporary storage area on the harddisk on a proper timing for the purpose of matching the contents of the temporarily inputted and outputted data to the contents of the data stored in the harddisk. In a case this kind of method is executed to cause the computer to repetitively refer to the same data stored in the harddisk, the following effect is offered. That is, it is possible to avoid increase of overhead burdened by a slow disk access. This is because the target data may be read from the cache and be used without having to access the harddisk in each referring time.

However, when the operating system allocates a free memory area to a cache without any limitation each time a program is executed to access a disk, the following disadvantage is brought about. That is, when another program accesses a disk, the program disables to secure a cache of a necessary size, which possibly makes the system performance of the computer remarkably lower.

Even if the cache of a necessary size cannot be secured, when almost of the memory is consumed up, the operating system reflects the data contents of the cache on the disk and executes the process of securing the usable memory area. However, in a case that a bulk memory is loaded in the computer, this process may have a great adverse effect on the system performance of the computer.

Today, generally, the amelioration of the computer performance causes one hardware computer to execute a plurality of tasks. For lessening the burden on the management including the foregoing cache resource problem, the method disclosed in JP-A-2004-326754 has been conventionally known. That is, this method causes one hardware computer to execute a plurality of virtual machines so that each virtual machine may execute a task independently. The virtual machine realizes a resource management by monitoring and allocating the resources for effectively using the resources on the real hardware, such as shown in US 2004/0221290 A1.

### SUMMARY

However, since the method disclosed in the JP-A-2004-326754 requires an enormous processing capability for implementing the virtual machines, this method is not suitable to implementation of a high-performance system. Hence, in the computerizing environment with a high cost-to-performance ratio, that is, the computerizing environment where various service programs are executed under the control of a single operating system, by realizing the resource management for securing a cache of a proper size, it is preferable to avoid lowering the system performance.

The present invention is made under the foregoing conditions, and it is an object of the present invention to realize a resource management for securing a cache of a proper size.

In carrying out the object, according to an aspect of the present invention, there is provided a method of controlling cache allocation being used in a computer that executes a plurality of programs on a single operating system. The computer includes a memory unit and a processing unit. For each program, the memory unit stores a memory of an allowable size secured as a disk cache by the program. When a new disk cache is allocated to the memory unit when the program is executed to cause the processing unit to access the disk drive, the processing unit operates to read the corresponding memory allowable size with the program from the memory unit and allocate the disk cache to the memory unit so that the disk cache may be accommodated in the read memory allowable size.

According to another aspect of the present invention, a method of controlling cache allocation includes the steps of: composing a computer having a memory unit provided with a disk drive and a processing unit for processing data stored in the memory unit; for a plurality of programs to be executed by the computer, storing a memory allowable size of a memory to be secured as a disk cache of each of the programs; reading at the processing unit the memory allowable size of one of the programs to be executed from the memory unit; comparing the read memory allowable size with a free area left in the memory unit; and in a case that the free area in the memory unit is larger than the read memory allowable size, allocating a memory of the same size as the memory allowable size included in the free memory area to the memory unit as a disk cache.

The present invention realizes a resource management for securing a cache of a proper size.

### BRIEF DESCRIPTION OF THE DRAWINGS

FIG. 1 is a block diagram. showing an arrangement of a server computer according to a first embodiment of the present invention;

FIG. 2 is an explanatory view showing the contents of cache management information shown in FIG. 1;

FIG. 3 is a flowchart showing a flow of computing a cache allocation to be executed in the server computer;

FIG. 4 is a flowchart showing a flow of computing a cache allocation to be executed in the server computer;

FIG. 5 is a block diagram showing an arrangement of a computer system according to a second embodiment of the present invention;

FIG. 6 is an explanatory view showing change of a cache allocation when a failure occurs; and

FIG. 7 is a flowchart showing a flow of a take-over process to be executed by the server computer.

### DESCRIPTION OF THE EMBODIMENTS

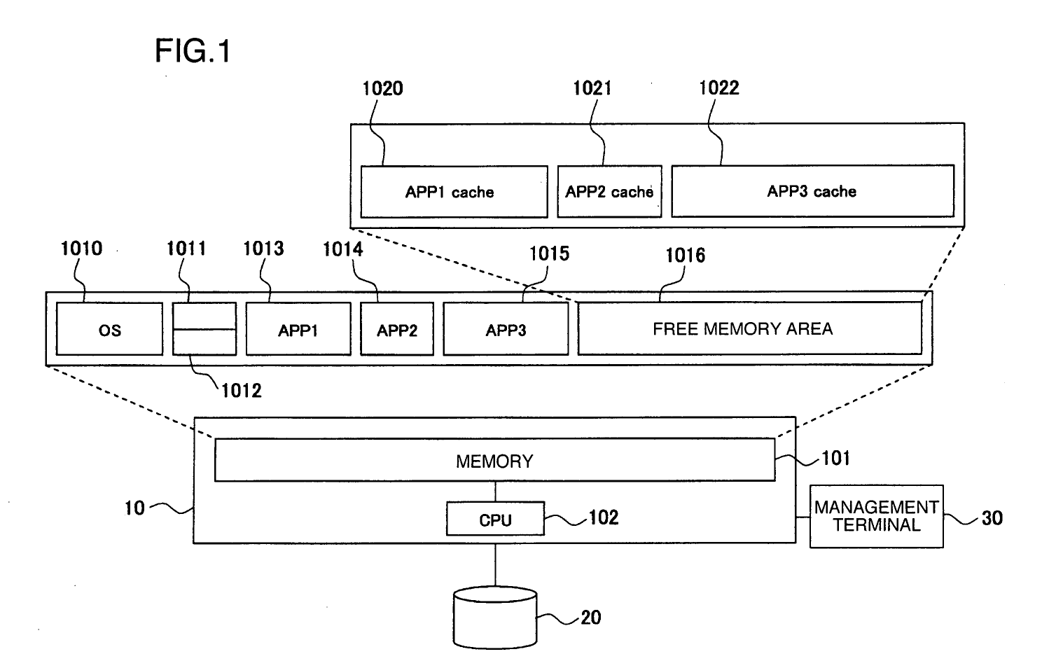

FIG. 1 is a block diagram showing an arrangement of a server computer according to a first embodiment of the present invention.

In FIG. 1, a server computer 10 is arranged to control transfer of information with a harddisk 20. The harddisk 20 (not shown) is made up of plural harddisk units as a harddisk group. The harddisk group composes a RAID (Redundant Arrays of Independent Disks).

The server computer 10 includes a memory (storage unit) 101 and a CPU (processing unit) 102. The memory 101 stores an operating system (often referred simply to as an OS) 1010, a cache management program (cache management function) 1011, cache management information 1012, and application programs (referred simply to as applications) 1013, 1014, 1015 (corresponding with “APP1”, “APP2” and “APP3” respectively). The memory 101 has a free memory area 1016. The foregoing arrangement allows the server computer 10 to read from the harddisk 20 to the OS 1010, the cache management program 1011, the cache management information 1012 and various applications 1013, 1014, 1015 and then execute those read programs.

For each of those applications 1013 to 1015, a memory area to be used as a cache, that is, memory areas of cache allocation sizes (memory restricted size, memory allowable size) 1020 to 1022 are allocated to the free memory area 1016. This allocation is determined by the cache management program 1011. That is, the memory size of the free memory area 1016 is determined by the program 1011.

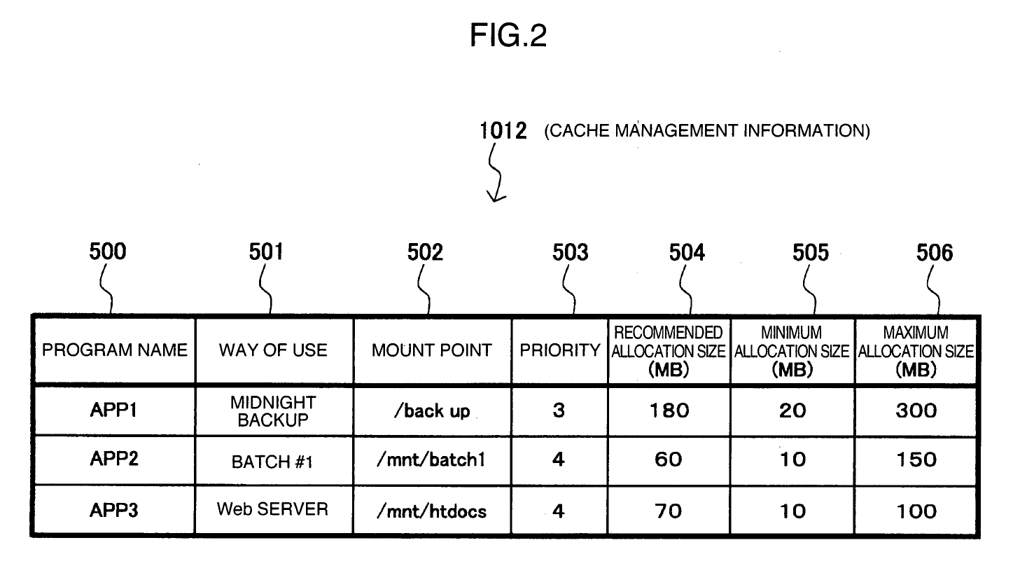

FIG. 2 is an explanatory view showing the contents of the cache management information 1012. As shown, the cache management information 1012 includes a program name 500, a way of use 501, a mount point 502, a priority 503, a recommended allocation size 504, a minimum allocation size 505, and a maximum allocation size 506. In this embodiment, the recommended allocation size 504, the minimum allocation size 505 and the maximum allocation size 506 are collectively called a memory allowable size.

The program name 500 is used for specifying an application to be executed. For example, it is often referred to as “APP1”. The way of use 501 indicates a way of use of an application to be executed. For example, a “midnight backup” is indicated as the way of use.

The mount point 502 is used for pointing to a mount point at which a device to be disk-cached or a network file system is to be mounted. The number of the mount points may be singular or plural. For example, for each application, two or more mount points may be set.

The priority 503 indicates importance of each application run on the server computer 10. Concretely, it indicates a priority to be given when a disk cache is allocated to each application. Ten priorities are prepared from the lowest priority “1” to the highest one “10”.

The recommended allocation size 504 represents a cache allocation size required so that the corresponding application may show its sufficient performance. The minimum allocation size 505 represents a minimum cache allocation size required for meeting the application performance requested by a user.

The maximum allocation size 506 represents an upper limit value of a cache size to be allocated to each application.

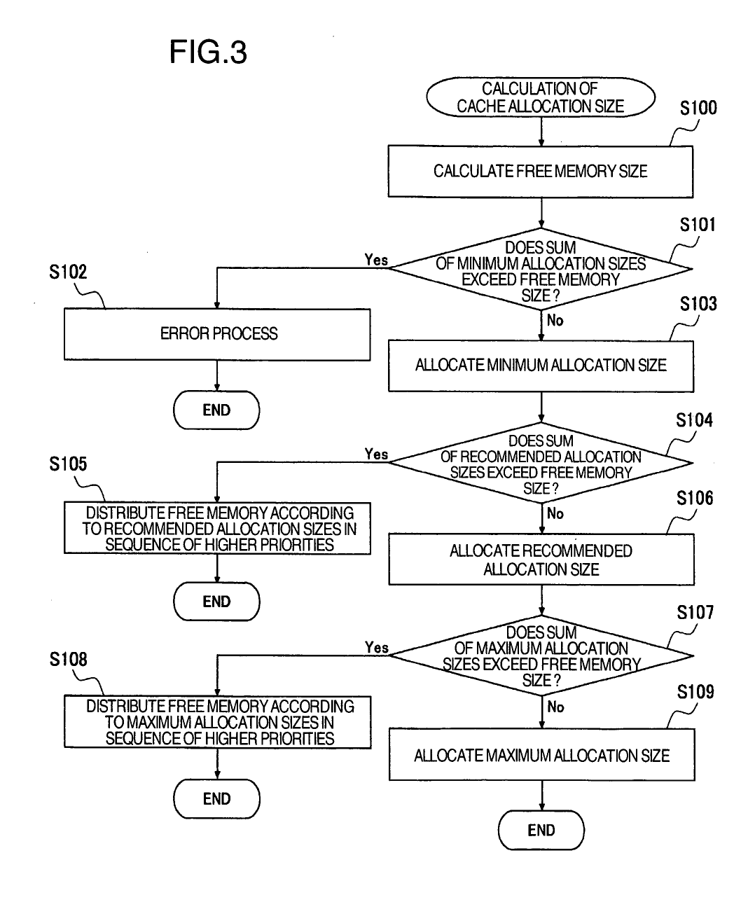

Next, the description will be turned to the process of calculating a cache allocation size to each of the foregoing applications 1013 to 1015 with reference to FIG. 3.

FIG. 3 shows a flow of calculating a cache allocation size in the server computer 10.

At first, the CPU 102 of the server computer 10 calculates a free memory size of the free memory area 1016 (see FIG. 1) in which the operating system 1010 or each application 1013 to 1015 is not allocated on the timing when the application 1015 is introduced (S100).

In succession, the CPU 102 reads from the cache management information 1012 (see FIG. 2) the minimum allocation size specified as the corresponding minimum allocation size 505 with each of the applications 1013 to 1015 and determines if a sum of the read minimum allocation sizes exceeds a free memory area (S101). In FIG. 2, the minimum allocation size of each of the applications 1013 to 1015 is 20 MB, 10 MB or 10 MB. The sum of those values is 40 MB, which corresponds to the sum of the minimum allocation sizes.

If it is determined that the sum exceeds the free memory size (Yes in S101), it means that the necessary cache allocation size is not secured. Hence, as an error message, the CPU 102 transmits this fact to a management terminal 30 (S102).

On the other hand, if it is determined that the sum does not exceed the free memory area (No in S101), the CPU 102 allocates the memory area of the minimum allocation size of each application 1013 to 1015 to the memory as the allocated cache (S103). That is, the memory area of each minimum allocation size is secured as the allocated cache.

Then, the CPU 102 reads from the cache management information 1012 (see FIG. 2) each recommended allocation size specified in the corresponding recommended allocation size 504 with each application 1013 to 1015 and then determines if the sum of the recommended allocation sizes exceeds the free memory size (S104). If it is determined that the sum exceeds the free memory size (Yes in S104), the CPU 102 distributes the free memory according to the corresponding recommended allocation size with each application 1013 to 1015 in sequence of the corresponding priority 503 with each application 1013 to 1015 (see FIG. 2) (S106).

For example, in FIG. 2, the recommended allocation sizes of the applications 1013 to 1015 are 180 MB, 60 MB and 70 MB and the priorities thereof are 3, 4 and 4. Hence, the free memory is distributed to those applications at that ratio and in sequence of these priorities.

Concretely, at first, the distribution of the free memory about the two applications 1014 and 1014 with the priority of “4” is carried out before the distribution about the application 1013 with the priority of “3”. That is, a memory size calculated by (free memory size)×60 MB/(180 MB+60 MB+70 MB) is distributed to the application 1014. Further, a memory size calculated by (free memory size)×70 MB/(180 MB+60 MB+70 MB) is distributed to the application 1015.

Next, the distributing operation is turned to the application 1013 with the priority of “3”. The memory size calculated by (free memory size)−(a total of the memory sizes distributed to the applications 1014 and 1015) is distributed to the application 1013. The aforementioned operations make it possible to distribute a usable memory area to the applications at a ratio of the recommended allocation sizes and in sequence of the higher priorities of the applications.

On the other hand, in a step S104, if it is determined that the sum does not exceed the free memory size (No in S104), the CPU 102 allocates the memories of the corresponding recommended allocation sizes with the applications 1013 to 1015 to those applications (S106). That is, the memory of each recommended allocation size can be secured as a cache allocation size.

Then, the CPU 102 reads from the cache management information 1012 (see FIG. 2) each maximum allocation size specified in the corresponding maximum allocation size 506 with each application 1013 to 1015 and then determines if a sum of these maximum allocation sizes exceeds a free memory size (S107). If it is determined that the sum exceeds the free memory size (Yes in S107), the CPU 102 distributes the free memory size according to the corresponding maximum allocation size with each application 1013 to 1015 and in sequence of the corresponding priority 503 with each application 1013 to 1015 (S108).

For example, in FIG. 2, the maximum allocation sizes of the applications 1013 to 1015 are 300 MB, 150 MB and 100 MB and the priorities thereof are 3, 4 and 4. Hence, the free memory is distributed at the ratio of those sizes and in sequence of these priorities.

Concretely, at first, the distribution of the free memory about the two applications 1014 and 1015 with the priority of “4” is carried out before the application 1013 with the priority of “3”. That is, a cache of a memory size calculated by (free memory size)×150 MB/(300 MB+150 MB+100 MB) is distributed to the application 1014. Further, a cache of a memory size calculated by (free memory size)×100 MB/(300 MB+150 MB+100 MB) is distributed to the application 1015.

Then, the distribution will be turned to the application 1013 with the priority of “3”. That is, a cache of a memory size calculated by (free memory size)−(a total of memory sizes distributed to the applications 1014 and 1015) is distributed to the application 1013. These distributing operations make it possible to distribute a cache of a usable memory size to the applications at the ratio of those maximum allocation sizes and in sequence of the higher priorities of the applications.

On the other hand, in a step S107, if it is determined that the sum does not exceed the free memory size (No in S107), the CPU 102 allocates the maximum allocation size of each application 1013 to 1015 to the free memory size (S109). This allocation allows the memory of the maximum allocation size of each application 1013 to 1015 to be secured as a cache.

Then, the description will be turned to the following case. That is, after the server computer 10 sets the cache allocation size (often referred to as the “set allocation size”) of each application 1013 to 1015 to the free memory area 1016, if a disk access occurs during execution of the application 1013, in response to a disk cache allocating request caused by the occurrence, the operating system 1010 and the cache management program 1011 executes the cache allocating process.

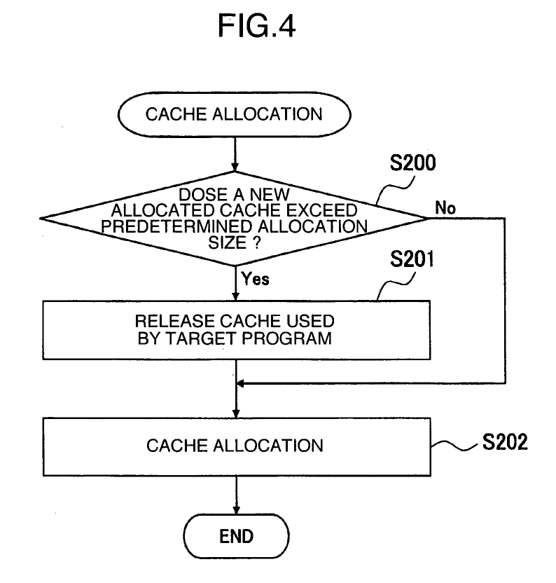

FIG. 4 shows a flow of a cache allocating process to be executed in the server computer 10.

At first, when the CPU 102 of the server computer 10 allocates a new cache to the free memory area 1016, the CPU 102 determines if the newly allocated cache exceeds the set allocation size (S200). The set allocation size corresponds with the application 1013 in which a disk access occurs and is read from a predetermined area of the memory 101. That is, in a step S200, the CPU 102 compares the set allocation size of the application 1013 with the total memory size (after allocation) used for the application 1013 and determines if the total memory size stays in the range of the set allocation size.

If it is determined that the total memory size exceeds the set allocation size (Yes in S200), the CPU 102 releases the cache having been used by the target application 1013 (S201). The release is executed by releasing the information with a low access frequency (such as a file) from the cache, for example.

Afterwards, the CPU 102 allocates a new cache to the cache released in the step S201 (S202). This makes it possible to release and allocate the cache to each application. This also makes it possible to prevent excessive increase of the cache allocation size caused by a disk access occurring in the specific application. This leads to preventing lowering of a processing performance of an overall system of the server computer 10.

As set forth above, according to this embodiment, in the server computer 10 for caching I/O contents on the memory 101 when inputting or outputting data onto or from a disk, for each application running on the server computer, a memory size to be allocated to the cache is limited. Then, if the cache usage of a specific application is closer to the set memory size, the cache spent by the concerned application is released for securing a free memory without having to have any influence on the cache used by another application. This results in being able to keep the disk access performance of the server computer 10.

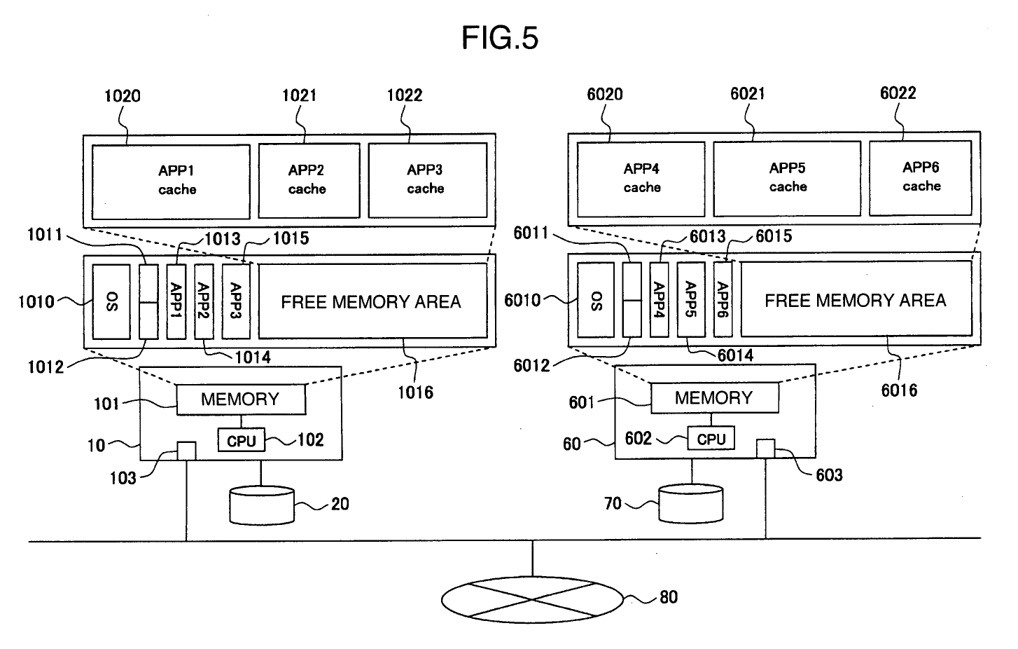

FIG. 5 is a block diagram showing an arrangement of a computer system according to a second embodiment of the present invention. The same components of the second embodiment as those of the first embodiments have the same reference numbers for the purpose of leaving out the double description.

The computer system according to the second embodiment includes plural server computers 10 and 60, both of which are connected through a network 80. For example, those computers may be arranged as an NAS (Network Attached Storage). The server computer 10 is different from that shown in FIG. 1 in a respect that it provides a network interface. In addition, in FIG. 5, two server computers are shown. In actual, however, three or more server computers may be connected with the network 80 for arranging a computer system.

Like the arrangement of the server computer 10, the server computer 60 includes a memory 601, a CPU 602 and a -network-interface 603. The-memory 602 stores an operating system 6010, a cache management program 6011, cache management information 6012, and applications 6013, 6014 and 6015 (corresponding to “APP4”, “APP5” and “APP6” respectively). The memory 101 has a free memory area 6016. Like the server computer 10, the server computer 60 arranged as described above reads from a harddisk 70 the operating system 6010, the cache management program 6011, the cache management information 6012, and various applications 6013 to 6015 and executes those programs. For each application 6013 to 6015, the cache management information 6012 serves to relate-a program name 500, a way of use 501, a mount point 502, a priority 503, a recommended allocation size 504, a minimum allocation size 505, and a maximum allocation size 506 with one another (which corresponds with the table of FIG. 2). The other arrangement of the computer system of the second embodiment is the same as that of the first embodiment.

The foregoing arrangement allows the server computer 60 to secure a cache of an allocation size of each application 6013 to 6015 in the free memory area 6016 (which corresponds with the process shown in FIG. 3) and allocate a cache of each predetermined allocation size 6020 to 6022 to each application 6013 to 6015. Then, the server computer 60 executes the cache allocation in response to the disk cache allocation request given by each application 6013 to 6015 (which corresponds to the process shown in FIG. 4).

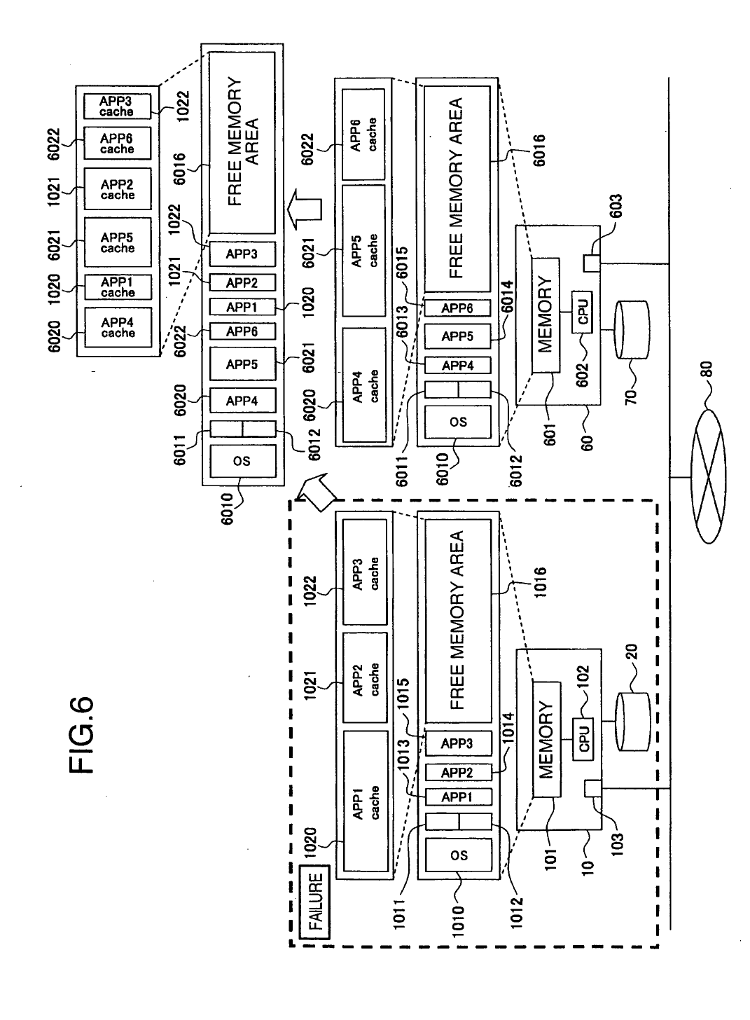

In this embodiment, those server computers 10 and 60 are arranged so that one server computer may monitor the operating state of the other server computer or vice versa through the network 80. Then, when a failure (such as a hardware failure) occurs in one of those server computers and thus the server computer disables to execute the application, the other server computer may take over the application and continues the process. The change of the cache allocation size in this case will be described with reference to FIG. 6.

FIG. 6 is an explanatory view showing a change of a cache allocation size provided when a failure occurs. The explanatory view of FIG. 6 concerns with the case in which the server computer 60 takes over the processes of the applications 1013 to 1015 because a failure occurs in the CPU 102 or the like of the server computer 10. For the take-over operation, the server computer 60 operates to allocate the caches of the allocation sizes 1020 to 1022 and 6020 to 6022 of the application 6013 to 6015 having been run before the take-over and the taken-over applications 1013 to 1015 to the free memory area 6016. (Refer to the right upper part of FIG. 6.) This operation is carried out because since the server computer 60 stores in the memory 601 the applications 1013 to 1015 being run in the server computer 10, the free memory area 6016 is made smaller than that before the take-over (refer to the right upper and lower parts of FIG. 6) and the cache of the allocation size of each application 1013 to 1015 and 6013 to 6015 is recalculated and reallocated on the basis of the size of the smaller free memory area 6016.

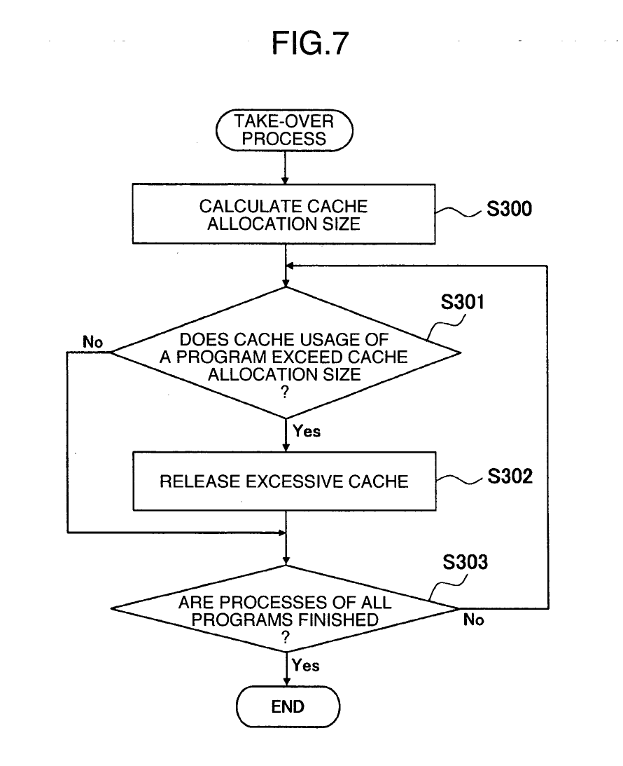

The take-over process including this reallocation will be described with reference to FIG. 7. FIG. 7 shows a flow of the take-over process to be executed by the server computer 60. This description will be expanded on the assumption that the server computer 10 in which a failure occurs operates to read from the memory 101 the cache management information 1012 and the applications 1013 to 1015 and transmit the read data to the server computer 60 through the network 80.

In a step S300, the CPU 602 of the server computer 60 calculates the cache allocation sizes of all the applications 1013 to 1015 and 6013 to 6015. This calculation of these cache allocation sizes is the same as the process shown in FIG. 3. Hence, the description thereabout is left out. This calculation results in determining the cache allocation sizes of all the applications 1013 to 1015 and 6013 to 6015.

In a step S301, the CPU 602 determines if a cache usage (before the take-over) of a certain program running before the take-over (for example, the application APP4) exceeds the cache allocation size calculated in the step S300.

If it is determined that the former does not exceed the latter (No in S301), the process goes to a step S303 (to be discussed below), while if it is determined that the former exceeds the latter (Yes in S301), the CPU 602 releases the excessive cache (S302). For example, the information whose access frequency is low (such as a file) is released out of the cache.

In the step S303, the CPU 602 determines if the processes (S301 and S302) about all the programs (such as the applications APP5 and APP6) running before the take-over are finished (S303). This operation is repeated until the processes S301 and S302 about all the applications are finished. Also at the time of the take-over of an application from a certain server computer 10 to another server computer 60, the latter server computer 60 allocates a sufficient-disk cache to the take-over application. This allocation makes it possible to avoid lowering the processing performance of the server computer far more.

Afterwards, when the failure of the server computer 10 is recovered and the server computer 10 may run the applications 1013 to 1015, the administrator manually switches the applications 1013 to 1015 from the server 60 to the server 10. In this case, the server computer 10 returns the cache allocation sizes of the applications 1013 to 1015 into the allocation sizes before the take-over under the control of the cache management program 1011. That is, the server computer 10 resets the cache allocation sizes by executing the calculation of the cache allocation size shown in FIG. 3. Then, the server computer 10 restarts the operations of the applications 1013 to 1015. This makes it possible to keep the minimum disk access performance even when a failure takes place in the computer system.

It goes without saying that the present invention is not limited to the foregoing first and second embodiments. The hardware arrangement, the data structure and the flow of process of the server computer may be transformed in various forms without departing from the spirit of the present invention.

It should be further understood by those skilled in the art that although the foregoing description has been made on embodiments of the invention, the invention is not limited thereto and various changes and modifications may be made without departing from the spirit of the invention and the scope of the appended claims.

1. A method of controlling cache allocation comprising the steps of:
storing a memory allowable size of a memory to be assigned as a cache for each of a plurality of programs to be executed by a computer having both a memory unit and a processing unit for processing data stored in the memory unit;
reading a memory allowable size for a program of said plurality of programs to be executed in a case that a cache is allocated to said memory unit under the control of said program being executed from said memory unit; and
allocating said cache to said memory unit so that an amount of capacity of said disk cache becomes larger than another amount of capacity of said memory allowable size having been assigned as the disk cache.

2. A method of controlling cache allocation according to claim 1, wherein said processing unit releases said memory assigned by said program and then allocates said disk cache to said memory unit so that an amount of capacity of said disk cache becomes larger than another amount of capacity of said read memory allowable size.

3. A method of controlling cache allocation used in a computer system having a plurality of computers connected through a network with each other, each of which computer executes a plurality of programs on a single operating system, comprising the step of:
detecting a failure occurring on a computer of the plurality of computers having been executing a program;
taking over the program having been executed to another computer through the network in response to the failure;
reading at the another computer from a memory unit in the another computer a memory allowable size of two or more programs including a program taken over; and
allocating a disk cache to the memory unit at a ratio of amounts of each of memory allowable sizes of the programs.

4. A method of controlling cache allocation according to claim 3, wherein when said failure is recovered, said computer whose failure is recovered reads from said memory unit said memory allowable size of each program before said take-over and reallocate a disk cache of said read memory allowable size to said memory unit.

5. A method of controlling cache allocation according to claim 1, wherein said processing unit of said computer allocates a disk cache to said memory unit for each of said programs according to a predetermined priority of each of said programs.

6. A method of controlling cache allocation according to claim 1, wherein said memory unit stores a recommended allocation size of said disk cache for each of said programs, and
said processing unit further operates to calculate an unoccupied memory size of said memory unit, read from said memory unit said recommended allocation size of each of said programs, determines if a sum of said read recommended allocation sizes exceed said calculated unoccupied memory size, and if it is determined that said sum does not exceed said free memory size, allocate said recommended allocation size of each of said programs as said memory allowable size of-each of said programs.

7. A method of controlling cache allocation according to claim 1, wherein said memory unit further stores a maximum allocation size of said disk cache for each of said programs, and
said processing unit further calculates a free memory size of said memory unit, reads from said memory unit said maximum allocation size of each of said programs, determine if a sum of said maximum allocation sizes exceeds said calculated unoccupied memory size, and if it is determined that said sum does not exceed said memory size, allocate said maximum allocation size of each of said programs as said memory allowable size of each of said programs.

8. A method of controlling cache allocation according to claim 6, wherein said memory further stores a priority that represents importance of each of said programs, and
if it is determined that said sum exceeds said unoccupied memory size, said processing unit allocates said memory allowable size in sequence of said higher priorities given to said programs.

9. A computer system including a plurality of computers including both a memory unit with a disk drive and a processing unit connected with each other through a network, each of the computers being used for executing a plurality of programs on a single operation system, comprising:
a memory for storing a memory-allowable size of a memory for each of said programs to be assigned as a disk cache for each of said programs;
a unit for reading a memory allowable size for a program of said plurality of programs to be executed in a case that a disk cache is allocated to said memory unit when accessing the disk drive under the control of said program being executed from said memory unit; and
another unit for allocating said disk cache to said memory unit so that an amount of capacity of said disk cache becomes larger than another amount of capacity of said memory allowable size having been assigned as the disk cache.

10. A computer system according to claim 9, wherein said processing unit releases said memory assigned by said program and then allocates said disk cache to said memory unit so that an amount of capacity of said disk cache becomes larger than another amount of capacity of said read memory allowable size.

11. A computer system according to claim 9, wherein when said program being run on one of said computers in which a failure occurs is taken over by another of said computers, said memory unit of said another computer further stores a memory allowable size of said disk for each of said programs, and said processing unit of said another computer reads from said memory unit said memory allowable unit corresponding with each of two or more programs including said taken-over program and allocates said disk cache to said another computer at a ratio of said memory allowable sizes of said programs.

12. A computer system according to claim 11, wherein if said failure of said computer is recovered, said memory unit of said computer whose failure is recovered further stores said memory allowable size of each of said programs before said take-over, and said processing unit of said computer whose failure is recovered reads from said memory said memory allowable size corresponding with each of said programs before said take-over and reallocates said disk cache to said memory unit of said computer whose failure is recovered on the basis of said memory allowable sizes of said programs.

13. A computer system according to claim 9, wherein said processing unit of said computer allocates a disk cache to said memory unit for each of said programs according to a predetermined priority of each of said programs.

14. A computer system according to claim 9, wherein said memory unit of said computer stores a recommended allocation size of said disk cache for each of said programs, and
said processing unit of said computer further calculates a free memory size of said memory unit, reads from said memory unit said recommended allocation size corresponding with each of said programs, determine if a sum of said recommended allocation sizes exceeds said calculated free memory size, and if it is determined that said sum does not exceed said free memory size, allocates said recommended allocation size corresponding with each of said programs as said memory allowable size of each of said programs.

15. A computer system according to claim 9, wherein said memory of said computer further stores a maximum allocation size of said disk cache for each of said programs, and said processing unit of said computer further reads from said memory unit said maximum allocation size corresponding with each of said programs, determine if a sum of said maximum allocation sizes exceeds said calculated free memory size, and if it is determined that said sum does not exceed said free memory size, allocates said maximum allocation size corresponding with each of said programs as said memory allowable size of each program.

16. A computer system according to claim 14, wherein said memory unit of said computer further stores a priority that represents importance of each of said programs, and
if it is determined that said sum exceeds said free memory size, said processing unit of said computer allocates said memory allowable size corresponding with each of said programs in sequence of higher priorities given to said programs.

17. A method of controlling cache allocation according to claim 3, wherein said processing unit of said computer allocates a disk cache to said memory unit for each of said programs according to a predetermined priority of each of said programs.

18. A method of controlling cache allocation according to claim 7, wherein said memory unit further stores a priority representing importance of each of said programs, and if it is determined that said sum exceeds said unoccupied memory area, said processing unit allocates a disk cache of said memory allowable size of each of said programs in sequence of higher priorities of said programs stored in said memory unit.

19. A computer system as claimed in claim 15, wherein said memory unit included in said computer further stores a priority representing importance of each of said programs, and if it is determined that said sum exceeds said free memory area, said processing unit included in said computer allocates a disk cache of said memory allowable size of each of said programs in sequence of higher priorities of said programs stored in said memory unit.

20. A method of controlling cache allocation according to claim 1, wherein an allocation of said cache to said memory unit is performed by comparing the read memory allowable size assigned with an amount of capacity of an unoccupied area in the memory unit, and by allocating a memory of the same size as the memory allowable size in the unoccupied area to the memory unit as the cache when the amount of capacity of the unoccupied area in the memory unit is larger than the read memory allowable size.
